(19) United States
(12) Patent Application Publication
(10) Pub. No.: US 2017/0013999 A1
(43) Pub. Date: Jan. 19, 2017

(54) Modular Fire Pit Apparatus

(71) Applicant: Global Outdoors, Inc., Narragansett, RI (US)

(72) Inventor: Michael Robert Horsfield, Wakefield, RI (US)

(73) Assignee: GLOBAL OUTDOORS, INC., Narragansett, RI (US)

(21) Appl. No.: 14/799,494

(22) Filed: Jul. 14, 2015

(51) Int. Cl. A47J 37/07

(52) U.S. Cl. CPC A47J 37/0763; A47J 2037/0777

(57) ABSTRACT

A modular fire pit apparatus provides, in at least one embodiment, a tray portion, a plurality of wall panels, a plurality of panel edge locks, and a lid portion. The wall panels are selectively engagable about a perimeter of the tray portion in a substantially vertical orientation, while also able to be arranged in a substantially horizontal orientation and stacked within the tray portion. The panel edge locks are configured for removable engagement with adjacently positioned ones of the wall panels. The lid portion is capable of removable engagement with the tray portion when the wall panels are stacked therewithin, while being further configured for removable engagement with a top edge of the wall panels when the wall panels are engaged about the perimeter of the tray portion. A bottom surface of the tray portion provides a set of legs configured for being selectively extended.

### RELATED APPLICATIONS

Not applicable.

### BACKGROUND

The subject of this patent application relates generally to portable heating devices, and more particularly to a modular fire pit apparatus configured for being selectively arranged into one of a self-contained, relatively compact stored state for easy portability and storage when not in use, and a selectively configurable deployed state when in use.

Applicant(s) hereby incorporate herein by reference any and all patents and published patent applications cited or referred to in this application.

By way of background, in many circumstances, it is desirable to have a compact or portable heating device for heating food, beverages, or other items when a conventional oven or stove is unavailable. For example, a portable heating device may be useful to people who camp or backpack and need a convenient way to heat food items wherever they may find themselves. The same is true for people who attend tailgating parties or similar events where access to stationary heating devices is not available. Similarly, it is common to find construction sites or remote work sites where no utilities are provided or no appliances are installed. In other situations, such as a natural disaster or power outage, an existing cooking appliance may be inoperable. In still other situations, it may be desirable to have such a compact or portable heating device for providing general warmth where a given location might not allow for a fire to be constructed on the ground, such as in a stationary fire pit. A portable heating device may be employed on such occasions and yet may be easily stored out of the way during the majority of the time when it is not needed. To facilitate being used in these ways, it is desirable to provide a heating implement that is portable, lightweight and compactly stored. It is also desirable that the unit operate independently of any particular immobile supply of energy such as an electrical wall socket or a natural gas line.

A number of portable heating devices have been commercially available or proposed by others, offering various degrees of compactness and suitability for various types of use. However, these known prior art devices do not adequately accommodate the need to selectively provide a modular solution that is not only able to be arranged into a self-contained, relatively compact stored state for easy portability and storage when not in use, but that is also capable of being selectively arranged into various configurations to safely suit the particular needs of a given heating context.

Aspects of the present invention fulfill these needs and provide further related advantages as described in the following summary.

### SUMMARY

Aspects of the present invention teach certain benefits in construction and use which give rise to the exemplary advantages described below.

The present invention solves the problems described above by providing a modular fire pit apparatus. In at least one embodiment, the apparatus provides a tray portion, a plurality of wall panels, a plurality of panel edge locks, and a lid portion. The wall panels are selectively engagable about a perimeter of the tray portion in a substantially vertical orientation, while being further configured for being selectively arranged in a substantially horizontal orientation and stacked within the tray portion. The panel edge locks are configured for removable engagement with adjacently positioned ones of the wall panels for assisting opposing side edges of said adjacently positioned wall panels to remain in substantially abutting contact. The lid portion is capable of removable engagement with the tray portion when the wall panels are stacked therewithin, while being further configured for removable engagement with a top edge of the wall panels when the wall panels are engaged about the perimeter of the tray portion. A bottom surface of the tray portion provides a set of legs configured for being selectively extended for elevating the tray portion a distance above the ground. The apparatus is capable of being selectively arranged into one of a self-contained, relatively compact stored state, wherein the lid portion is engaged with the tray portion and wall panels and panel edge locks are positioned therewithin, and a selectively configurable deployed state, wherein the legs are extended from the bottom surface of the tray portion, at least one of the wall panels is selectively engaged about the perimeter of the tray portion, and the lid portion is engagable with a top edge of the at least one wall panel, thereby forming a container for receiving burning materials therewithin

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary modular fire pit apparatus in a deployed state, in accordance with at least one embodiment;

FIG. 2 is a perspective view of the exemplary modular fire pit apparatus in a stored state, in accordance with at least one embodiment; and

FIGS. 3-6 are further perspective views of the exemplary modular fire pit apparatus while transitioning between the stored state and the deployed state, in accordance with at least one embodiment.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

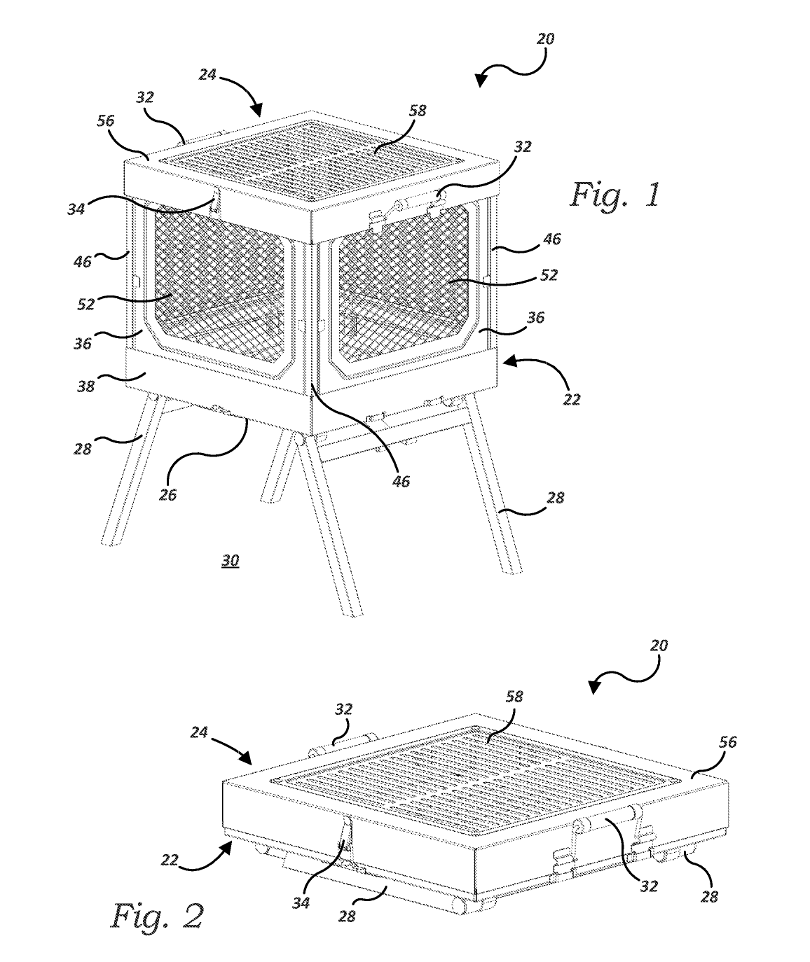

Turning now to FIGS. 1 and 2, there is shown a perspective view of an exemplary embodiment of a modular fire pit apparatus 20. In at least one embodiment, as discussed further below, the apparatus 20 is capable of being selectively arranged into one of a self-contained, relatively compact stored state (FIG. 2) for easy portability and storage when not in use, and a selectively configurable deployed state (FIG. 1) when in use.

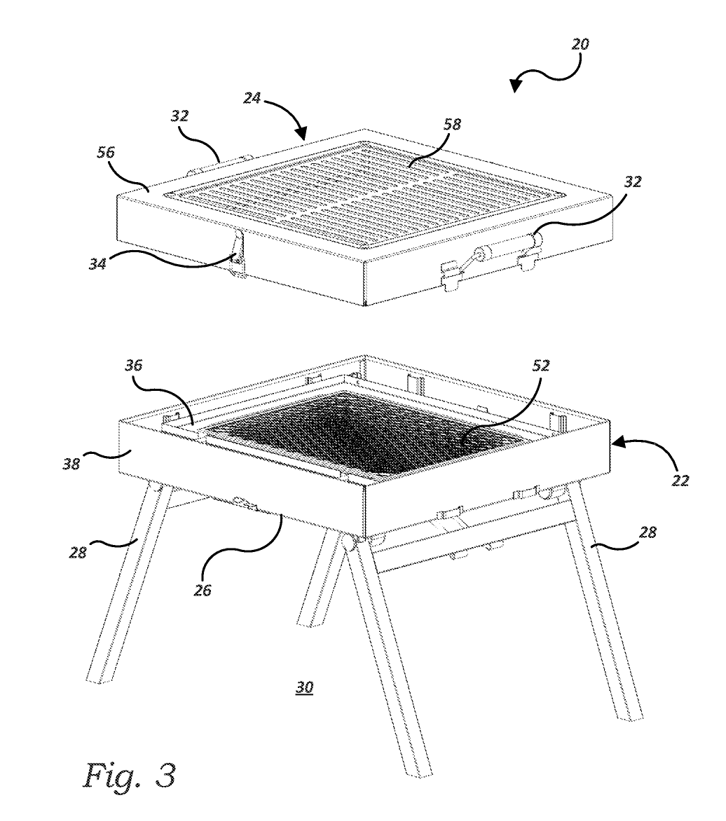

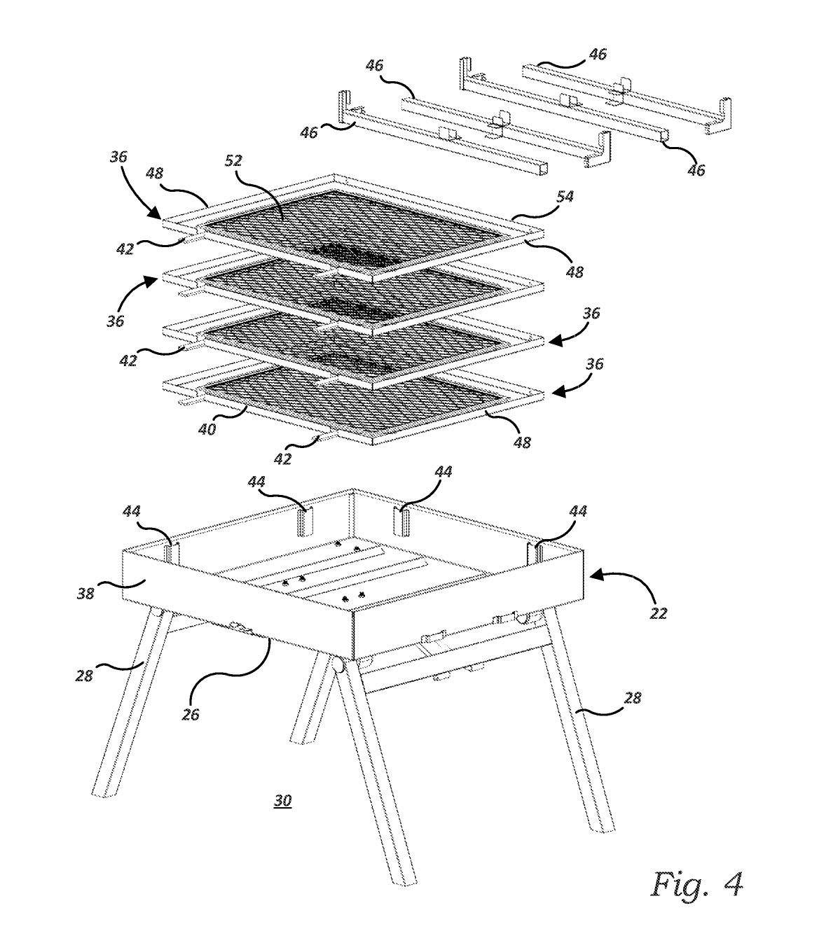

In at least one embodiment, as best shown in FIGS. 3 and 4, the apparatus 20 provides a tray portion 22 and a lid portion 24. The lid portion 24 is sized and shaped for approximating the dimensions of the tray portion 22, such that the lid portion 24 is capable of removable engagement with the tray portion 22 when the apparatus 20 is in the stored state (FIG. 2). As illustrated in FIG. 2, in at least one embodiment, the apparatus 20 is roughly the size of a traditional briefcase when in the stored state. However, it should be noted that in further embodiments, the apparatus 20 may take on any other dimensions—larger or smaller; thus, the present invention should not be read as being so limited to the dimensions shown in the drawings. Furthermore, while the tray portion 22 and lid portion 24 are shown as being substantially square-shaped in the drawings, in further embodiments, the tray portion 22 and lid portion 24 may take on any other shape now known or later conceived (i.e., triangle, rectangle, pentagon, octagon, circle, etc.). In at least one embodiment, the various components of the apparatus 20 are constructed of metal. However, in alternate embodiments, the various components of the apparatus 20 may be constructed of any other heat-resistant material (or combination of materials), now known or later developed.

With continued reference to FIG. 3, in at least one embodiment, a bottom surface 26 of the tray portion 22 provides a set of legs 28 configured for being selectively extended for elevating the tray portion 22 a distance above the ground 30 (or a similar surface on which the apparatus 20 may be positioned) when the apparatus 20 is in the deployed state. In at least one such embodiment, the legs 28 are configured for being selectively folded up against the bottom surface 26 of the tray portion 22 when the apparatus 20 is in the stored state. In at least one alternate embodiment, the legs 28 are removably engagable with the bottom surface 26 of the tray portion 22, such that the legs 28 may be selectively removed when the apparatus 20 is in the stored state. In at least one such alternate embodiment, the tray portion 22 is sized and configured for storing the removably engagable legs 28 therewithin when the apparatus 20 is in the stored state. In still further embodiments, the legs 28 may be configured or otherwise engaged with the bottom surface 26 using any other mechanism (or combination of mechanisms), now known or later developed, that allow the legs 28 to be moved into a relatively compact or low profile position relative to the tray portion 22 when the apparatus 20 is in the stored state. For example, in at least one such embodiment, the legs 28 may be selectively telescoping. It should also be noted that the particular number and arrangement of the legs 28 as shown in the drawings is merely exemplary. In alternate embodiments, the apparatus 20 may incorporate any number and/or arrangement of legs 28.

With continued reference to FIG. 3, in at least one embodiment, the lid portion 24 provides an at least one handle 32 positioned and configured for assisting in both carrying the apparatus 20 when in the stored state, as well as lifting the lid portion 24 and selectively disengaging it from the tray portion 22 during use, as discussed further below. In the exemplary embodiment, the lid portion 24 provides a pair of opposing handles 32. However, it should be noted that the particular number and arrangement of the handles 32 as shown in the drawings is merely exemplary. In alternate embodiments, the apparatus 20 may incorporate any number and/or arrangement of handles 32. Additionally, in at least one embodiment, the handles 32 may be positioned on the tray portion 22—either in addition to or in lieu of handles 32 positioned on the lid portion 24.

As mentioned above, in at least one embodiment, the lid portion 24 is capable of removable engagement with the tray portion 22 when the apparatus 20 is in the stored state (FIG. 2). In at least one such embodiment, as best shown in FIG. 3, the lid portion 24 provides an at least one latch 34 positioned and configured for selectively locking the lid portion 24 to the tray portion 22 when the apparatus 20 is in the stored state—thereby preventing the lid portion 24 from becoming unintentionally disengaged from the tray portion 22. In the exemplary embodiment, the lid portion 24 provides a pair of opposing latches 34. However, it should be noted that the particular number and arrangement of latches 34 as shown in the drawings is merely exemplary. In alternate embodiments, the apparatus 20 may incorporate any number and/or arrangement of latches 34. Additionally, in at least one embodiment, the latches 34 may be positioned on the tray portion 22—either in addition to or in lieu of latches 34 positioned on the lid portion 24. In still further embodiments, any other structure or mechanism (or combinations thereof)—now known or later developed—capable of allowing the lid portion 24 to be removably engageable with the tray portion 22 as described herein may be substituted.

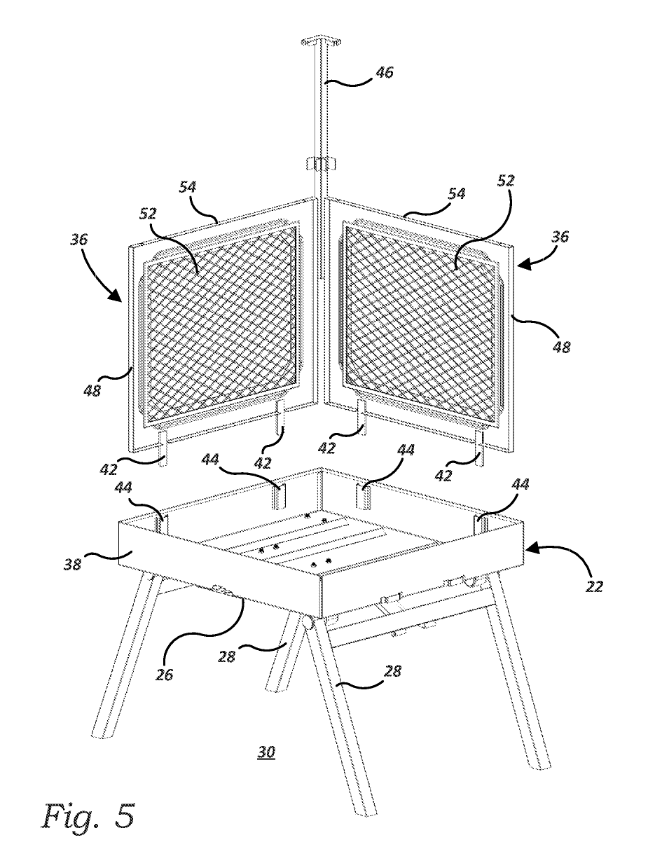

With continued reference to FIGS. 3 and 4, in at least one embodiment, the tray portion 22 is sized and configured for storing a plurality of wall panels 36 therewithin when the apparatus 20 is in the stored state—the wall panels 36 being arranged in a substantially horizontal orientation so that they may be stacked within the tray portion 22 (FIG. 3). When the apparatus 20 is in the deployed state, the wall panels 36 are configured for being removably engaged about a perimeter of the tray portion 22 in a substantially vertical orientation. In at least one such embodiment, the wall panels 36 are configured for being removably engaged with a substantially vertically-oriented perimeter wall 38 of the tray portion 22. In at least one embodiment, as best shown in FIG. 5, a bottom edge 40 of each wall panel 36 provides an at least one tab 42 configured for being slidably inserted into a corresponding slot 44 provided by the perimeter wall 38 of the tray portion 22. In at least one alternate embodiment, where the tray portion 22 does not provide a perimeter wall 38, the corresponding slots 44 may be provided by the bottom surface 26, arranged around the perimeter of the tray portion 22. It should be noted that the particular number and arrangement of tabs 42 and corresponding slots 44 as shown in the drawings is merely exemplary. In alternate embodiments, the apparatus 20 may incorporate any number and/or arrangement of tabs 42 and slots 44. Furthermore, in at least one alternate embodiment, the tabs 42 are positioned on the tray portion 22, while the slots 44 are positioned on the wall panels 36. In still further alternate embodiments, any other structure or mechanism (or combinations thereof)—now known or later developed—capable of allowing the wall panels 36 to be removably engageable with the tray portion 22 as described herein may be substituted.

In at least one embodiment, as best shown in FIGS. 4 and 5, the tray portion 22 is further sized and configured for storing a plurality of panel edge locks 46 therewithin when the apparatus 20 is in the stored state. When the apparatus 20 is in the deployed state, the panel edge locks 46 are configured for removable engagement with adjacent wall panels 36 for assisting opposing side edges 48 of the adjacent wall panels 36 to remain in substantially abutting contact when the wall panels 36 are engaged with the tray portion 22, thereby increasing the stability of the substantially vertically-oriented wall panels 36. In at least one such embodiment, each of the panel edge locks 46 is configured for slidably receiving the opposing side edges 48 of two adjacently positioned wall panels 36. In alternate embodiments, any other structure or mechanism (or combinations thereof)—now known or later developed—capable of allowing each wall panel 36 to be removably engageable with adjacent wall panels 36 as described herein may be substituted.

In at least one embodiment, with each wall panel 36 so engaged with both the tray portion 22 as well as with the adjacent wall panels 36, the apparatus 20 forms a container 50 configured for receiving wood and/or other burning materials. It should be noted that the modularity of the wall panels 36 allows for one or more of the wall panels 36 to be selectively omitted when arranging the apparatus 20 in the deployed state, so as to enable side-access into the container 50 during use (in contexts where such access might be desirable). It should also be noted that the particular number, shape and size of the wall panels 36 as shown in the drawings is merely exemplary. In alternate embodiments, the apparatus 20 may incorporate any number of wall panels 36, as well as wall panels 36 of various shapes and sizes, including non-planar wall panels 36—dependent, in part, on the corresponding shape and size of the tray portion 22 and lid portion 24.

In at least one embodiment, each wall panel 36 provides a screen portion 52 configured for enabling air to pass therethrough. Accordingly, when the apparatus 20 is in the deployed state, the screen portions 52 allow air flow into and out of the formed container 50, while also preventing hot embers from escaping the container 50, as well as other objects (such as hands or feet) from entering the container 50. It should be noted that the particular size and shape of the screen portions 52 as shown in the drawings is merely exemplary. In alternate embodiments, the screen portions 52 may take on any other size or shape, now known or later conceived, either spanning the entire wall panel 36, or simply a portion of the wall panel 36.

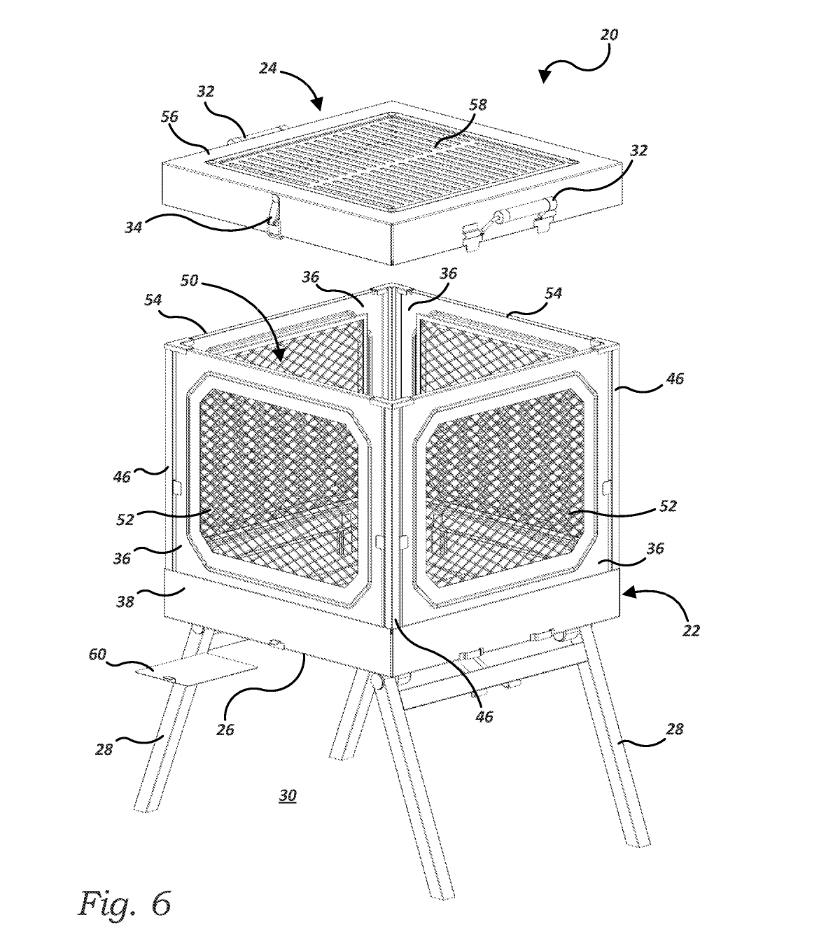

In at least one embodiment, as best illustrated in FIGS. 1 and 6, the lid portion 24 is capable of removable engagement with a top edge 54 of the wall panels 36, when the apparatus 20 is in the deployed state, thereby selectively enclosing the formed container 50. In at least one embodiment, the lid portion 24 is simply positionable in contact with the top edge 54 of the wall panels 36. In at least one further embodiment, the at least one latch 34 of the lid portion 24 is capable of selectively locking the lid portion 24 to the top edge 54 of the wall panels 36—thereby preventing the lid portion 24 from becoming unintentionally disengaged from the wall panels 36. In still further embodiments, any other structure or mechanism (or combinations thereof)—now known or later developed—capable of allowing the lid portion 24 to be removably engageable with the top edge 54 of the wall panels 36 as described herein may be substituted.

With continued reference to FIGS. 1 and 6, in at least one embodiment, a top surface 56 of the lid portion 24 provides a grate 58 configured for being used as a cooking surface when the apparatus 20 is in the deployed state. It should be noted that the particular size and shape of the grate 58 as shown in the drawings is merely exemplary. In alternate embodiments, the grate 58 may take on any other size or shape, now known or later conceived, either spanning the entire top surface 56 of the lid portion 24, or simply a portion of the top surface 56.

In at least one embodiment, as shown in FIG. 6, the tray portion 22 provides an at least one cleanout panel 60 engaged with the bottom surface 26 of the tray portion 22 and configured for being selectively moved between a closed position, wherein the cleanout panel 60 blocks access to a cleanout hole (not shown) in the bottom surface 26 of the tray portion 22, and an open position (FIG. 6), wherein the cleanout hole is at least partially unobstructed, thereby allowing select contents of the formed container 50 (such as ash, for example) to exit therethrough. In at least one such embodiment, the cleanout panel 60 is slidably engaged with the bottom surface 26 of the tray portion 22. In another such embodiment, the cleanout panel 60 is hingedly engaged with the bottom surface 26 of the tray portion 22. In still further embodiments, any other mechanism (or combination of mechanisms)—now known or later developed—capable of allowing the cleanout panel 60 to be engaged with the bottom surface 26 of the tray portion 22 as described herein may be substituted.

Accordingly, then, in at least one embodiment, the apparatus 20 is capable of being selectively arranged into one of the self-contained, relatively compact stored state—wherein, at least one of the wall panels 36, panel edge locks 46, and legs 28 are positioned within the tray portion 22, and the lid portion 24 is engaged with the tray portion 22—for easy portability and storage when not in use, and the selectively configurable deployed state—wherein, the legs 28 are extended from the bottom surface 26 of the tray portion 22, at least one of the wall panels 36 is selectively engaged with the tray portion 22 in a substantially vertical orientation, and the lid portion 24 is engagable with the top edge 54 of the at least one wall panel 36, thereby forming the container 50 for receiving wood and/or other burning materials—when in use.

Aspects of the present specification may also be described as follows:

1. A modular fire pit apparatus comprising: a tray portion; a plurality of wall panels selectively engagable about a perimeter of the tray portion in a substantially vertical orientation, the wall panels further configured for being selectively arranged in a substantially horizontal orientation and stacked within the tray portion; a plurality of panel edge locks configured for removable engagement with adjacently positioned ones of the wall panels for assisting opposing side edges of said adjacently positioned wall panels to remain in substantially abutting contact; a lid portion capable of removable engagement with the tray portion when the wall panels are stacked therewithin, the lid portion further configured for removable engagement with a top edge of the wall panels when the wall panels are engaged about the perimeter of the tray portion; and a bottom surface of the tray portion providing a set of legs configured for being selectively extended for elevating the tray portion a distance above the ground; whereby, the apparatus is capable of being selectively arranged into one of a self-contained, relatively compact stored state, wherein the lid portion is engaged with the tray portion and wall panels and panel edge locks are positioned therewithin, and a selectively configurable deployed state, wherein the legs are extended from the bottom surface of the tray portion, at least one of the wall panels is selectively engaged about the perimeter of the tray portion, and the lid portion is engagable with a top edge of the at least one wall panel, thereby forming a container for receiving burning materials therewithin.

2. The modular fire pit apparatus according to embodiment 1, wherein the legs are configured for being selectively folded up against the bottom surface of the tray portion when the apparatus is in the stored state.

3. The modular fire pit apparatus according to embodiments 1-2, wherein the legs are removably engagable with the bottom surface of the tray portion, such that the legs may be selectively removed when the apparatus is in the stored state.

4. The modular fire pit apparatus according to embodiments 1-3, wherein the tray portion is sized and configured for storing the removably engagable legs therewithin when the apparatus is in the stored state.

5. The modular fire pit apparatus according to embodiments 1-4, wherein the lid portion provides an at least one handle.

6. The modular fire pit apparatus according to embodiments 1-5, wherein the lid portion provides a pair of opposing handles.

7. The modular fire pit apparatus according to embodiments 1-6, wherein the lid portion provides an at least one latch positioned and configured for selectively locking the lid portion to the tray portion when the apparatus is in the stored state.

8. The modular fire pit apparatus according to embodiments 1-7, wherein the lid portion provides a pair of opposing latches.

9. The modular fire pit apparatus according to embodiments 1-8, wherein the at least one latch is further configured for selectively locking the lid portion to the top edge of the at least one wall panel when the apparatus is in the deployed state.

10. The modular fire pit apparatus according to embodiments 1-9, wherein the wall panels are configured for being removably engaged with a substantially vertically-oriented perimeter wall of the tray portion.

11. The modular fire pit apparatus according to embodiments 1-10, wherein a bottom edge of each wall panel provides an at least one tab configured for being slidably inserted into a corresponding slot provided by the perimeter wall of the tray portion.

12. The modular fire pit apparatus according to embodiments 1-11, wherein each of the panel edge locks is configured for slidably receiving the opposing side edges of two adjacently positioned wall panels.

13. The modular fire pit apparatus according to embodiments 1-12, wherein at least a portion of each wall panel provides a screen portion configured for enabling air to pass therethrough when the apparatus is in the deployed state.

14. The modular fire pit apparatus according to embodiments 1-13, wherein the screen portion of each wall panel spans the entire wall panel.

15. The modular fire pit apparatus according to embodiments 1-14, wherein at least a portion of a top surface of the lid portion provides a grate configured for being used as a cooking surface when the apparatus is in the deployed state.

16. The modular fire pit apparatus according to embodiments 1-15, wherein the grate spans the entire top surface of the lid portion.

17. The modular fire pit apparatus according to embodiments 1-16, wherein the tray portion provides an at least one cleanout panel engaged with the bottom surface of the tray portion and configured for being selectively moved between a closed position, wherein the cleanout panel blocks access to a cleanout hole in the bottom surface of the tray portion, and an open position, wherein the cleanout hole is at least partially unobstructed, thereby allowing select contents of the formed container to exit therethrough.

18. The modular fire pit apparatus according to embodiments 1-17, wherein the tray portion, wall panels, and lid portion are constructed of metal.

19. A modular fire pit apparatus comprising: a tray portion having a substantially vertically-oriented perimeter wall; a plurality of wall panels selectively engagable with the perimeter wall of the tray portion in a substantially vertical orientation, the wall panels further configured for being selectively arranged in a substantially horizontal orientation and stacked within the tray portion; a plurality of panel edge locks configured for removable engagement with adjacently positioned ones of the wall panels for assisting opposing side edges of said adjacently positioned wall panels to remain in substantially abutting contact; a lid portion capable of removable engagement with the tray portion when the wall panels are stacked therewithin, the lid portion further configured for removable engagement with a top edge of the wall panels when the wall panels are engaged about the perimeter of the tray portion; and a bottom surface of the tray portion providing a set of legs configured for being selectively extended for elevating the tray portion a distance above the ground; whereby, the apparatus is capable of being selectively arranged into one of a self-contained, relatively compact stored state, wherein the lid portion is engaged with the tray portion and wall panels and panel edge locks are positioned therewithin, and a selectively configurable deployed state, wherein the legs are extended from the bottom surface of the tray portion, at least one of the wall panels is selectively engaged about the perimeter of the tray portion, and the lid portion is engagable with a top edge of the at least one wall panel, thereby forming a container for receiving burning materials therewithin.

20. A modular fire pit apparatus comprising: a tray portion; a plurality of wall panels selectively engagable about a perimeter of the tray portion in a substantially vertical orientation, the wall panels further configured for being selectively arranged in a substantially horizontal orientation and stacked within the tray portion; each wall panel providing a screen portion configured for enabling air to pass through the wall panel; a plurality of panel edge locks configured for removable engagement with adjacently positioned ones of the wall panels for assisting opposing side edges of said adjacently positioned wall panels to remain in substantially abutting contact; a lid portion capable of removable engagement with the tray portion when the wall panels are stacked therewithin, the lid portion further configured for removable engagement with a top edge of the wall panels when the wall panels are engaged about the perimeter of the tray portion; a top surface of the lid portion providing a grate configured for being used as a cooking surface; and a bottom surface of the tray portion providing a set of legs configured for being selectively extended for elevating the tray portion a distance above the ground; whereby, the apparatus is capable of being selectively arranged into one of a self-contained, relatively compact stored state, wherein the lid portion is engaged with the tray portion and wall panels and panel edge locks are positioned therewithin, and a selectively configurable deployed state, wherein the legs are extended from the bottom surface of the tray portion, at least one of the wall panels is selectively engaged about the perimeter of the tray portion, and the lid portion is engagable with a top edge of the at least one wall panel, thereby forming a container for receiving burning materials therewithin.

In closing, regarding the exemplary embodiments of the present invention as shown and described herein, it will be appreciated that a modular fire pit apparatus is disclosed and configured for being selectively arranged into one of a self-contained, relatively compact stored state for easy portability and storage when not in use, and a selectively configurable deployed state when in use. Because the principles of the invention may be practiced in a number of configurations beyond those shown and described, it is to be understood that the invention is not in any way limited by the exemplary embodiments, but is generally directed to a modular fire pit apparatus and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention. Furthermore, the various features of each of the above-described embodiments may be combined in any logical manner and are intended to be included within the scope of the present invention.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the term “about.” As used herein, the term “about” means that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein.

The terms “a,” “an,” “the” and similar referents used in the context of describing the present invention (especially in the context of the following claims) are to be construed to cover both the singular and the plural, unless otherwise indicated herein or clearly contradicted by context. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

Specific embodiments disclosed herein may be further limited in the claims using consisting of or consisting essentially of language. When used in the claims, whether as filed or added per amendment, the transition term “consisting of” excludes any element, step, or ingredient not specified in the claims. The transition term “consisting essentially of” limits the scope of a claim to the specified materials or steps and those that do not materially affect the basic and novel characteristic(s). Embodiments of the present invention so claimed are inherently or expressly described and enabled herein.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A modular fire pit apparatus comprising:
a tray portion;
a plurality of wall panels selectively engagable about a perimeter of the tray portion in a substantially vertical orientation, the wall panels further configured for being selectively arranged in a substantially horizontal orientation and stacked within the tray portion;
a plurality of panel edge locks configured for removable engagement with adjacently positioned ones of the wall panels for assisting opposing side edges of said adjacently positioned wall panels to remain in substantially abutting contact;
a lid portion capable of removable engagement with the tray portion when the wall panels are stacked therewithin, the lid portion further configured for removable engagement with a top edge of the wall panels when the wall panels are engaged about the perimeter of the tray portion; and
a bottom surface of the tray portion providing a set of legs configured for being selectively extended for elevating the tray portion a distance above the ground;
whereby, the apparatus is capable of being selectively arranged into one of a self-contained, relatively compact stored state, wherein the lid portion is engaged with the tray portion and wall panels and panel edge locks are positioned therewithin, and a selectively configurable deployed state, wherein the legs are extended from the bottom surface of the tray portion, at least one of the wall panels is selectively engaged about the perimeter of the tray portion, and the lid portion is engagable with a top edge of the at least one wall panel, thereby forming a container for receiving burning materials therewithin.

2. The modular fire pit apparatus of claim 1, wherein the legs are configured for being selectively folded up against the bottom surface of the tray portion when the apparatus is in the stored state.

3. The modular fire pit apparatus of claim 1, wherein the legs are removably engagable with the bottom surface of the tray portion, such that the legs may be selectively removed when the apparatus is in the stored state.

4. The modular fire pit apparatus of claim 3, wherein the tray portion is sized and configured for storing the removably engagable legs therewithin when the apparatus is in the stored state.

5. The modular fire pit apparatus of claim 1, wherein the lid portion provides an at least one handle.

6. The modular fire pit apparatus of claim 5, wherein the lid portion provides a pair of opposing handles.

7. The modular fire pit apparatus of claim 1, wherein the lid portion provides an at least one latch positioned and configured for selectively locking the lid portion to the tray portion when the apparatus is in the stored state.

8. The modular fire pit apparatus of claim 7, wherein the lid portion provides a pair of opposing latches.

9. The modular fire pit apparatus of claim 7, wherein the at least one latch is further configured for selectively locking the lid portion to the top edge of the at least one wall panel when the apparatus is in the deployed state.

10. The modular fire pit apparatus of claim 1, wherein the wall panels are configured for being removably engaged with a substantially vertically-oriented perimeter wall of the tray portion.

11. The modular fire pit apparatus of claim 10, wherein a bottom edge of each wall panel provides an at least one tab configured for being slidably inserted into a corresponding slot provided by the perimeter wall of the tray portion.

12. The modular fire pit apparatus of claim 1, wherein each of the panel edge locks is configured for slidably receiving the opposing side edges of two adjacently positioned wall panels.

13. The modular fire pit apparatus of claim 1, wherein at least a portion of each wall panel provides a screen portion configured for enabling air to pass therethrough when the apparatus is in the deployed state.

14. The modular fire pit apparatus of claim 13, wherein the screen portion of each wall panel spans the entire wall panel.

15. The modular fire pit apparatus of claim 1, wherein at least a portion of a top surface of the lid portion provides a grate configured for being used as a cooking surface when the apparatus is in the deployed state.

16. The modular fire pit apparatus of claim 15, wherein the grate spans the entire top surface of the lid portion.

17. The modular fire pit apparatus of claim 1, wherein the tray portion provides an at least one cleanout panel engaged with the bottom surface of the tray portion and configured for being selectively moved between a closed position, wherein the cleanout panel blocks access to a cleanout hole in the bottom surface of the tray portion, and an open position, wherein the cleanout hole is at least partially unobstructed, thereby allowing select contents of the formed container to exit therethrough.

18. The modular fire pit apparatus of claim 1, wherein the tray portion, wall panels, and lid portion are constructed of metal.

19. A modular fire pit apparatus comprising:
a tray portion having a substantially vertically-oriented perimeter wall;
a plurality of wall panels selectively engagable with the perimeter wall of the tray portion in a substantially vertical orientation, the wall panels further configured for being selectively arranged in a substantially horizontal orientation and stacked within the tray portion;
a plurality of panel edge locks configured for removable engagement with adjacently positioned ones of the wall panels for assisting opposing side edges of said adjacently positioned wall panels to remain in substantially abutting contact;
a lid portion capable of removable engagement with the tray portion when the wall panels are stacked therewithin, the lid portion further configured for removable engagement with a top edge of the wall panels when the wall panels are engaged about the perimeter of the tray portion; and
a bottom surface of the tray portion providing a set of legs configured for being selectively extended for elevating the tray portion a distance above the ground;
whereby, the apparatus is capable of being selectively arranged into one of a self-contained, relatively compact stored state, wherein the lid portion is engaged with the tray portion and wall panels and panel edge locks are positioned therewithin, and a selectively configurable deployed state, wherein the legs are extended from the bottom surface of the tray portion, at least one of the wall panels is selectively engaged about the perimeter of the tray portion, and the lid portion is engagable with a top edge of the at least one wall panel, thereby forming a container for receiving burning materials therewithin.

20. A modular fire pit apparatus comprising:
a tray portion;
a plurality of wall panels selectively engagable about a perimeter of the tray portion in a substantially vertical orientation, the wall panels further configured for being selectively arranged in a substantially horizontal orientation and stacked within the tray portion;
each wall panel providing a screen portion configured for enabling air to pass through the wall panel;
a plurality of panel edge locks configured for removable engagement with adjacently positioned ones of the wall panels for assisting opposing side edges of said adjacently positioned wall panels to remain in substantially abutting contact;
a lid portion capable of removable engagement with the tray portion when the wall panels are stacked therewithin, the lid portion further configured for removable engagement with a top edge of the wall panels when the wall panels are engaged about the perimeter of the tray portion;
a top surface of the lid portion providing a grate configured for being used as a cooking surface; and
a bottom surface of the tray portion providing a set of legs configured for being selectively extended for elevating the tray portion a distance above the ground;
whereby, the apparatus is capable of being selectively arranged into one of a self-contained, relatively compact stored state, wherein the lid portion is engaged with the tray portion and wall panels and panel edge locks are positioned therewithin, and a selectively configurable deployed state, wherein the legs are extended from the bottom surface of the tray portion, at least one of the wall panels is selectively engaged about the perimeter of the tray portion, and the lid portion is engagable with a top edge of the at least one wall panel, thereby forming a container for receiving burning materials therewithin.
